(19) United States
(12) Patent Application Publication
(10) Pub. No.: US 2023/0358058 A1
(43) Pub. Date: Nov. 9, 2023

(54) FLOOR COVERING WITH FIREPROOF WEAR LAYER

(71) Applicant: GERFLOR, VILLEURBANNE (FR)

(72) Inventors: Alexia BALAMOUTOFF, Lyon (FR); Nicolas CINAUSERO, FONTAINES SAINT MARTIN (FR)

(21) Appl. No.: 18/002,646

(22) PCT Filed: Jun. 23, 2021
(86) PCT No.: PCT/FR2021/051142

§ 371 Date: Dec. 20, 2022

(30) Foreign Application Priority Data
Jul. 2, 2020 (FR) 2006972

(51) Int. Cl. E04F 15/10; B32B 7/12; B32B 27/08; B32B 27/12; B32B 27/30

(52) U.S. Cl. CPC E04F 15/107; E04F 15/102; E04F 15/105; B32B 7/12; B32B 27/08; B32B 27/12; B32B 27/304; B32B 2307/3065; B32B 2307/7376; B32B 2250/02; B32B 2250/03

(57) ABSTRACT

The present invention relates to a multi-layer floor covering comprising, from the base to the top of the covering:
a back layer A,
a decorative layer B,
a surface layer C,
   the decorative layer B being advantageously in the form of a printed substrate or an ink layer printed on the back layer A or on the back of the surface layer C,
   the surface layer C comprising:
a polymer matrix comprising polyvinyl chloride, and
a mineral filler comprising hydrotalcite, the hydrotalcite being used as fireproofing and having a rate of incorporation, by weight, in the polymer matrix that is greater than or equal to 3%, preferably greater than or equal to 5%.

### TECHNICAL FIELD

The present invention relates to a multi-layer covering intended to be used as a floor covering, in particular, for passenger transport vehicles, for example, in the terrestrial, maritime, rail transport and aeronautical fields.

### PRIOR ART

In the transport field, in particular maritime, rail or aeronautical transport, manufacturers are constantly looking for new materials to reduce equipment costs (train, boat, aircraft).

For example, this may involve optimising the operation of the device by developing and using new materials which have satisfactory physical properties, in particular the reduction of smoke emissions and the opacity of the smoke generated in the event of fire from or in the device.

In particular, manufacturers have sought to improve these properties for floor coverings.

In general, a floor covering consists of a plurality of layers assembled together. In particular, an aeronautical floor covering may comprise a reinforcing layer in contact with the ground which ensures the rigidity of the covering. In addition, a surface layer (also called a wear layer) provides, in particular, wear or abrasion resistance properties. The surface layer may also have the function of protecting a possible decorative or printing layer on which patterns can be printed that can be seen by a user of the device.

Relating to the improvement of the anti-smoke properties of floor coverings, document CN 109487985 describes a floor covering comprising a transparent layer, a decorative layer, and a back layer comprising, among other things, hydrotalcite as a fire retardant or flame retardant.

This document, CN 109487985, like most documents, uses a back layer containing flame retardants, and limits the thickness of the transparent polyvinyl chloride (PVC) wear layer.

However, this approach does not significantly reduce the toxicity and opacity of any smoke in the event of a fire.

Document WO 2017/201802 describes an alternative for producing a wear or back layer, in that it proposes to manufacture them in thermoplastic polyurethane (TPU) instead of plasticised PVC. The toxicity of any smoke generated in the event of fire from or in the multi-layer coating is thus reduced.

A major drawback of this alternative is that TPU costs significantly more than PVC, with similar or even lower mechanical properties. On the other hand, the use of TPU requires the incorporation of flame retardants so as not to degrade the fire resistance properties of the covering, in particular, flame propagation.

Furthermore, in addition to its wear, abrasion or slip resistance properties, the surface layer must generally be transparent, in particular, when it covers a decorative layer provided with a pattern which must be visible to the users of the apparatus.

However, the solutions described in the prior art, consisting in adding conventional flame retardants such as aluminium hydroxide ATH or fillers in the transparent surface layer, lead to a degradation or even a loss of its transparency.

### DISCLOSURE OF THE INVENTION

An aim of the invention is to provide a multi-layered floor covering making it possible to overcome the drawbacks mentioned above.

The invention particularly aims at providing such a multi-layer floor covering making it possible to reduce the quantity, the toxicity and the opacity of any smoke emitted in the event of fire from or in said covering.

Another aim of the invention is to provide such a multi-layer floor covering which also makes it possible to benefit from the good mechanical properties and the relatively low cost of PVC compared with other polymers which can be used in such coverings.

To this end, the invention provides a multi-layer floor covering comprising, from the base to the top of the covering:
a back layer A,
a decorative layer B, advantageously being in the form of a printed substrate or an ink layer printed on the back layer A or on the back of the surface layer C,
a surface layer C,
   wherein the surface layer C comprises:
a polymer matrix comprising polyvinyl chloride (PVC), and
a mineral filler comprising hydrotalcite, the hydrotalcite being used as a flame retardant and representing at least 3%, preferably at least 5%, relative to the weight of the surface layer C.

The hydrotalcite has the advantage of being easily dispersed in PVC, without altering the colours or the transparency of PVC, and providing flame-retardant properties.

In a particular embodiment, the difference, in absolute value, between the refraction index of polyvinyl chloride and the refraction index of hydrotalcite is less than or equal to 0.1. Polyvinyl chloride and hydrotalcite may have identical refraction indices.

Surprisingly, the Applicant has discovered that the use of hydrotalcite as a flame-retardant mineral filler to manufacture a surface layer comprising polyvinyl chloride (PVC), while respecting an amount of at least 3%, preferably at least 5%, relative to the weight of the surface layer C, makes it possible:
on the one hand, to reduce the quantity, toxicity and opacity of any smoke emitted in the event of fire from or in said covering, and
on the other hand, to maintain the transparency of the surface layer, thus leaving the underlying decorative layer visible to the users of the apparatus in which the covering is positioned.

In fact, hydrotalcite, used according to the present invention as a flame retardant, has the advantage of being well dispersed in PVC, and does not alter the colours or the transparency of the polymer material after processing.

In a particular embodiment, the quantity, by weight, of hydrotalcite in the surface layer C is less than 35%, preferably less than 20%, more preferably less than 10%. A quantity of less than 35% makes it possible to significantly improve the flame retardancy while limiting the impact on the transparency of PVC. A quantity of less than 10%, by weight, makes it possible to obtain a surface layer with a transparency which is substantially identical to the same surface layer without hydrotalcite. In other words, a quantity of less than 10%, by weight, makes it possible not to alter the transparency of the surface layer while providing the flame-retardant properties.

The term “transparent layer” is generally understood to mean a layer with a contrast value which is greater than 47. The contrast can be measured by means of a spectrocolorimeter, for example, according to the following measurement conditions: illuminant D65, observer 10°, a measurement geometry of d/8° (diffuse of 8°), and a specular component including SCI (making it possible to overcome the influence of the shine).

The back layers A, decorative layers B, and surface layers C are preferably successive, i.e., are in contact with each other. At least two of them may optionally be separated by an adhesive layer, for example a hot-melt film, a thermo-adhesive film or a heat-bonding film. The hot-melt film, thermo-adhesive film or heat-bonding film is particularly suitable when the decorative layer B is a complex printed substrate comprising a grid and a non-woven fabric. In contrast, when the decorative layer B is a printed substrate of the PVC film type, a conventional assembly without adhesive can be implemented, for example, by thermolamination.

Alternatively, said back layers A, decorative layers B, and surface layers C may be mutually separated from each other by other intermediate layers.

In this regard, in the remainder of the present text, the fact that a first layer is arranged on (respectively under) a second layer means that the first layer is located above (respectively below) the second layer when the layer is observed from its base to its top, but does not necessarily imply direct contact between the first layer and the second layer.

In general, a layer comprises two main faces corresponding to an upper face and to a lower face.

The Back Layer A

The back layer A, also called the “intermediate layer”, adds thickness to the floor covering.

It can be arranged on an underlying reinforcing layer as will be described in the remainder of the present text.

The back layer A makes it possible, in particular, to ensure good weldability on the edges of the covering. This is particularly the case when gaskets are applied at the edge of the product to ensure that the edges of the floor covering are sealed. This sealing can be achieved by heat welding by using a weld bead or sealants. The good mechanical strength of the seal may depend not only on the materials used but also on the contact surface, and therefore, in particular, on the thickness of the product.

In addition, the back layer A provides opacity when a decorative layer, or a printed layer, on which patterns are printed is positioned on it, or on an upper layer, thus acting as a background allowing a user to better distinguish the patterns printed on the overlying decorative layer by contrast with the back layer A.

According to one embodiment, the layer A comprises a reinforcing layer, preferably a reinforcing grid, interposed between two back layers A and A″. In this case, the layer A thus comprises, from its base to its top, a first back layer, a reinforcing layer, and a second back layer A″. The two back layers A and A″ may have identical or different compositions. This embodiment is particularly suitable when the layer B does not comprise a reinforcing layer, preferably a glass grid and a non-woven fabric, as explained in the remainder of the present text.

Advantageously, the back layer A comprises a polymer selected from the group consisting of polyvinyl chloride, ethylene vinyl acetate copolymer and mixtures thereof.

Advantageously, the back layer A either comprises, or is essentially composed of polyvinyl chloride.

Advantageously, the back layer A does not comprise polyurethane or thermoplastic polyurethane.

The mass per unit surface area of the back layer A is preferably between 300 g/m² and 3000 g/m², more advantageously between 600 g/m² and 2200 g/m². In particular, for applications in the rail transport or marine field, the mass per unit surface area of the back layer A is preferably between 1500 g/m² and 2500 g/m², more advantageously between 2100 g/m² and 2200 g/m². For applications in the aeronautics field, the mass per unit surface area of the back layer A is preferably between 500 g/m² and 1200 g/m², more advantageously between 600 g/m² and 1000 g/m².

The back layer A has a thickness advantageously of between 0.1 mm and 5 mm, more advantageously of between 0.2 mm and 2 mm, even more advantageously of between 0.3 mm and 1.5 mm, and more preferably of between 1.3 mm and 1.45 mm

According to a particular embodiment, the back layer A comprises fillers, in particular, inorganic fillers, for example clays, silica or calcium carbonate, singly or as a mixture.

These fillers may represent from 30% to 80% by weight, relative to the weight of the back layer A, advantageously from 50% to 70% by weight, alternately 40% to 60% by weight.

According to another particular embodiment, the back layer A results from an assembly of two layers obtained from the same polymer, one of the two layers containing more inorganic fillers than the other to reduce the cost of the final product.

For example, the back layer A may be obtained by assembling a first layer comprising between 40% and 60% of inorganic fillers by weight and a second layer comprising between 20% and 40% of inorganic fillers by weight, the fillers representing from 30% to 80% by weight, relative to the weight of the back layer A obtained (first+second layers), advantageously from 50% to 70% by weight, alternatively from 40% to 60% by weight.

For example, the back layer A may be obtained by assembling a first lower layer comprising between 40% and 60%, preferably approximately 50%, of hydrotalcite by weight, and a second upper layer comprising between 40% and 60%, preferably approximately 50%, by weight of a composition comprising between 50% and 100% inorganic fillers and between 0% and 50% hydrotalcite by weight.

According to another particular embodiment, the back layer A comprises at least one additive, such as a plasticiser, a flame retardant (for example, hydrotalcite or aluminium trihydroxide), and/or pigments.

The flame retardants may, in particular, be from the family of metal oxides such as antimony oxide, magnesium oxide or zinc oxide, as well as compounds from the family of metal hydroxides, including aluminium trihydroxide (ATH), boehmite (AOOH), magnesium dihydroxide (MDH), lamellar double hydroxides (in particular, hydrotalcites), hydromagnesite or a mixture of hydromagnesite and huntite. These flame retardants may be used singly or as a mixture. Known mixtures are, for example, GATH in combination with MDH, this mixture allows an effect over a wider temperature range.

Advantageously, the back layer A comprises between 0% and 80% of at least one flame retardant, more advantageously between 5% and 65%, by weight relative to the weight of the back layer A.

Advantageously, the back layer A also comprises synergists and/or smoke suppressors, in particular, compounds from the family of metal oxides and/or hydroxides, such as magnesium oxide, zinc oxide, zinc stannate, zinc hydroxy stannate, zinc molybdate, calcium molybdate, calcium and zinc molybdate. These synergists and/or smoke suppressors may be used singly or as a mixture. Synergists and/or smoke suppressors are generally effective only when combined with flame retardant(s), whose effect(s) they enhance or whose action(s) they complement.

Advantageously, the back layer A comprises between 0% and 20% synergists and/or smoke suppressors, advantageously between 0.5% and 8%, by weight of synergists and/or smoke suppressors, by weight relative to the weight of the back layer A.

Advantageously, the back layer A comprises a mixture 1) of flame retardants and 2) of synergists and/or smoke suppressors, this mixture comprising at least one metal oxide and one metal hydroxide.

Preferably and in such a manner as to limit the number of different constituents in the composition of the floor covering, the back layer A comprises hydrotalcite as the sole flame-retardant. This makes it possible to use the same flame retardant in the surface layer C and in the back layer A.

Preferably, the back layer A comprises plasticised PVC, i.e., PVC to which one or more plasticisers have been added. Plasticised PVC may also be referred to as flexible PVC. More preferably, the back layer comprises plasticised PVC and, as the sole flame retardant, hydrotalcite, as well as, optionally, inorganic fillers such as calcium carbonate.

For example, the plasticizer may be a phosphate ester plasticiser. It may, in particular, be selected from the group comprising DIDP (diisodecyl phthalate), DINP (diisononyl phthalate) and phosphate ester plasticisers.

This additive of the back layer A may represent from 10% to 30%, advantageously from 12% to 18% by weight, by weight, relative to the weight of the back layer A.

The Decorative Layer B

The decorative layer B, also known as the printing layer, is advantageously arranged on the back layer A. It is advantageously in the form of a printed substrate or an ink layer printed on the back layer A or on the reverse side of the surface layer C.

The decorative layer B may also result from the presence of pigments in the layer A and/or in the layer B.

The pattern or decoration may be printed on the upper face of the decorative layer B, that is to say the face of the decorative layer B which is located opposite the lower face of the surface layer C.

In an embodiment, the decorative layer B comprises a printed substrate and the back layer A comprises pigments. A pattern is then formed by the combination of the pigments in the back layer A and the decorative layer B. For example, the pigments in the back layer A may form a plain background which highlights by contrast the pattern printed on the decorative layer B.

According to a preferred embodiment, in particular, when it is in the form of a printed substrate, the decorative layer B comprises a substrate which can also play the role of reinforcing the floor covering. As such, the substrate may comprise reinforcing fibres or may be a reinforcing means such as a grid, a woven fabric or a non-woven fabric.

Alternatively, the decorative layer B may be a film, preferably devoid of any reinforcing fibres. In this case, the decorative layer B preferably comprises a thermoplastic polymer selected from the group comprising resins, for example, polyvinyl chloride (PVC), polyolefins, polyethylene terephthalate (PET) or glycolised polyethylene terephthalate (PETG), and mixtures thereof.

Preferably, the decorative layer B comprises a printed substrate consisting of a complex in the form of a glass grid and a polyester non-woven fabric, on which a pattern is printed.

This substrate may advantageously be coated before printing. It may be a gelled PVC plastisol covering.

Advantageously, only one of the back layer A and the decorative layer B comprises a reinforcement, for example, reinforcement fibres or a reinforcing grid.

The decorative layer B is advantageously bonded to the surface layer via an adhesive layer H. In a particular case, to make the surface layer C adhere well to the decorative layer B, the adhesive layer H may be located between the decorative layer B and the back layer A, which makes it possible to bond the surface layer C by passing through and diffusing the adhesive into the decorative layer B during processing when the layer B is selected as a complex.

The layer of adhesive H is, for example, a hot-melt film or a heat-bonding film, of the copolyamide or copolyester or thermoplastic polyurethane type.

The pattern or decoration may be printed by any known technique(s), in particular, by gravure printing or by digital printing.

Alternatively, the decorative layer B may consist of an ink layer printed directly on the lower face of the surface layer C, facing the back layer A, or on the upper face of the back layer A, facing the surface layer C.

The Surface Layer C

The surface layer C, also called the wear layer, is arranged on the decorative layer B. It has resistance properties, in particular, to stains, soiling, abrasion and slipping. It can also incorporate layer B when the latter is an ink layer printed on the reverse side of the surface layer C.

As already stated, the surface layer C comprises:
a polymer matrix comprising polyvinyl chloride, and
a flame-retardant mineral filler comprising hydrotalcite.

Preferably, the polymer matrix comprises plasticised PVC (defined in the presentation of layer A). More preferably, the polymer matrix comprises, or is essentially composed of plasticised PVC.

The layer C may be protected by a layer of varnish C′ to improve the resistance to stains and soiling of the floor covering. When it is present, the layer C′ is deposited on the layer C, that is to say on the face opposite the face which is facing the layer B.

For example, the plasticizer may be a phosphate ester plasticiser. In particular, it may be identical to or different from that of the back layer A. Plasticisers of the non-phosphate type or of the phthalate type may also be selected. For example, the plasticiser may be selected from DIDP (diisodecyl phthalate), DINP (diisononyl phthalate), DINCH (diisononyl hexahydrophthalate) and plasticisers of phosphate ester type, such as 2-ethylhexyldiphenyl phosphate.

The surface layer C may comprise between 0 and 50 per of plasticiser, preferably 30 per and 45 per (1 per=1 part per hundred parts by weight of resin, the resin corresponding to the polymer matrix of the layer C).

Hydrotalcite is part of the family of lamellar double hydroxides (Layered Double Hydroxide, or LDH), or anionic clay, much less present in the natural state than cationic clays, which has been studied only since the 1960s. Hydrotalcite being the most well-known mineral in the HDL family, this family is often called, by extension or imprecisely, the hydrotalcite family Differentiation may be done by the type of cations and anions contained in the mineral (see, in particular, the thesis “Les Hydroxydes Doubles Lamellaires au coeur de la biotechnologie: evaluation des applications médicales et environnementales” [“Lamellar Double Hydroxides at the Heart of Biotechnology: Evaluation of Medical and Environmental Applications”], Mohamed Amine Djebbi, 2017). However, the nomenclature of HDLs remains complex and often leads to confusion.

The general formula of the lamellar double hydroxide is advantageously as follows:

[M^{II}₁₋ₓM^{III}ₓ(OH)₂]^{x+}[Aⁿ⁻_{x/n},yH₂O] with:
M^{II} and M^{III}: respectively, divalent metal cations (e.g., magnesium Mg²⁺ and/or Zn²⁺ ions in the case of hydrotalcite) and trivalent metal cations (e.g., aluminium Al³⁺ ions in the case of hydrotalcite),
Aⁿ⁻: interfoliar anions (e.g., carbonate ions CO₃²⁻ in the case of hydrotalcites),
x: charge density (generally between 0.20 and 0.33),
y being the number of water molecules generally between 0 and 10,
n being between 1 and 3.

The lamellar double hydroxide corresponding to this formula has a stack of the following pair of layers:
a layer with the formula [M^{II}₁₋ₓ, M^{III}ₓ(OH)₂]^{x+},
an interfoliar space with the formula [Aⁿ⁻_{x/n}(H₂O)_{y}].

The laminar structure may include stacking one or more pairs of sheets.

The anions interposed between the sheets of formula [M^{II}₁₋ₓM^{III}ₓ(OH)₂]^{x+} ensure the neutrality of the hydrotalcite and are solvated by the water molecules also present in this interfoliar space.

Preferably, the hydrotalcite used in the surface layer C is of the Mg—Zn—Al or Mg—Al type.

Two non-limiting examples of hydrotalcites which can be used in covering of the invention are as follows:

[MgₓZn_{y}Al₂(OH)_{2(2+x+y)}]CO₃,nH₂O(x=2-4,y=2-4,n=0-10),

[MgₓAl₂(OH)₂₍₂₊ₓ₎]CO₃,nH₂O(x=4-6,n=0-10).

Preferably, the layer C comprises, or is essentially composed of PVC (advantageously plasticised) and hydrotalcite.

According to a preferred embodiment, the hydrotalcite represents from 5% to 50% by weight, and preferably from 9% to 33%, by weight relative to the weight of the surface layer C.

The surface layer C has a thickness advantageously of between 0.1 mm and 2 mm, preferably of between 0.1 mm and 1.5 mm

The assembly formed by the back layers A, decorative layers B and surface layers C may be used as such as a covering for various applications, for example, maritime transport.

Preferably, the hydrotalcite is in the form of particles having a size advantageously of between 200 nm and 1 μm, preferably of between 400 μm and 700 μm.

Hydrotalcite particles which are smaller than 100 nm are considered to be nanometric particles. On the other hand, hydrotalcite particles which are larger than 1 μm may possibly alter the transparency of the surface layer C.

In general, the size designates the largest dimension of the particles, e.g., the diameter for spherical particles or the length for cylindrical or rod-shaped particles.

The size generally refers to the median size D50. Thus, in general, 50% by number of the particles are smaller in size than the size indicated above and 50% by number larger in size.

The Reinforcing Layer A′

According to a particular embodiment, the assembly formed by the back layers A, decorative layers B, and surface layers C may be assembled to a fibrous reinforcing layer A′, advantageously via an adhesive layer B′.

This embodiment is particularly suitable for applications where the mechanical stresses are high and require the presence of a reinforcing layer at the base of the covering, such as air transport, in particular. In this case, the layer A and/or the bilayer A/A″ and/or the layer B may also comprise fibrous reinforcement (fibres, grid, woven or non-woven fabrics).

Where appropriate, the fibrous reinforcing layer A′ corresponds to the base, i.e., the lowest layer of the multi-layer covering. It is then intended to be in contact with the ground on which the covering is installed. The multi-layer covering can thus rest on the floor panel of, for example, an aircraft, the interface between the fibrous reinforcing layer A′ and the floor being provided by means of an adhesive.

The fibrous reinforcing layer A′ comprises fibres advantageously in the form of a fabric, a grid, or a non-woven fabric.

The fibrous reinforcing layer A′ may be composed of a composite material comprising fibres, and a thermosetting or thermoplastic polymer resin.

Advantageously, the fibrous reinforcing layer A′ comprises, by weight relative to the weight of said layer A′:
from 20% to 80% of reinforcing fibres, more advantageously from 45% to 60%,
from 20% to 80% of polymer resin, more advantageously from 40% to 55%.

The reinforcing fibres (whatever their shape: individualised fibres, woven or non-woven fabrics, grids, etc.) participate in stiffening the layer which contains them (A, A′, A″ or B, or between A and A″). They may be either mineral or organic. In particular, the fibres providing reinforcement in a material may be either natural or synthetic. These fibres may be organic or inorganic material. They are preferably fibres of a material selected from the group comprising glass, carbon, aramid, flax, and hemp. The fibres may be coated, for example, in a thermosetting polymer resin.

The polymer resin of the fibrous reinforcing layer A′ may, in particular, comprise a thermosetting or thermoplastic polymer advantageously selected from the group comprising: polyester resin, phenolic resin, epoxy resin, polysulphone, vinyl ester resin, epoxy-acrylic resin, and mixtures thereof.

According to a particular implementation, the fibrous reinforcing layer A′ may consist of glass fibres coated in a thermosetting or thermoplastic polymer resin, for example a phenolic resin. This embodiment is particularly suitable for the aeronautical field.

According to a particular embodiment, the fibrous reinforcing layer A′ may consist of a non-woven fabric, advantageously made of polyester, laminated, preferably with a copolyester adhesive. This embodiment is particularly suitable for the rail transport field and promotes bonding to the floor.

The mass per unit surface area of the fibrous reinforcing layer, may, in particular be between 200 g/m² and 1200 g/m², more advantageously between 300 g/m² and 600 g/m².

On the other hand, the fibrous reinforcing layer A′ has a thickness advantageously of between 0.05 mm and 1.5 mm, more advantageously of between 0.2 mm and 0.6 mm, even more advantageously of between 0.2 mm and 0.4 mm

According to another particular embodiment, the fibrous reinforcing layer A′ comprises an adhesive making it possible to bond the floor covering to a floor. In this particular case, the fibrous reinforcing layer A′ may have a mass per unit surface area greater than the range of 200-1200 g/m².

As mentioned above, the fibrous reinforcing layer A′ is intended to be in contact with the floor, for example, of an aircraft, on which the multi-layer covering is deposited. It is advantageously integrated into the back layer A by virtue of the adhesive layer B′.

The adhesive layer B′ may, in particular, be made of a polymer selected from the group comprising: copolyamides (CoPA), thermoplastic polyurethane (TPU), polyurethane (PU), ethylene vinyl acetate (EVA), copolyesters, and mixtures thereof.

The mass per unit surface area of the adhesive layer B′, may, in particular be between 10 g/m² and 140 g/m², more advantageously between 30 g/m² and 100 g/m².

On the other hand, the adhesive layer B′ has a thickness advantageously of between 0.02 mm and 0.5 mm, more advantageously of between 0.04 mm and 0.12 mm.

As already indicated, the adhesive layer B′ makes it possible to ensure the combination of the fibrous reinforcing layers A′ and back layers A. In fact, the resins or polymers of the fibrous reinforcing layers A′ and back layers A are often not very compatible, because the polymer resin of the fibrous reinforcing layer A′, preferably selected from the group of thermosetting resins, is generally not very compatible with the components of the back layer A, which are advantageously thermoplastic.

In a non-limiting manner, the fibrous reinforcing layer A′ may be replaced by a fabric sub-layer and/or a foamed sub-layer and/or an adhesive-backed sub-layer. A fabric sub-layer may, in particular, promote bonding to the ground, in particular, to the floor of a train, using an acrylic-based adhesive or an MS polymer.

Fabric sub-layer are, for example, woven or non-woven fabric sub-layers, for example a polyester non-woven fabric at 80 g/m². An adhesive-backed sub-layer may, in particular, have a back face coated with an adhesive to facilitate the installation of the floor covering.

An adhesive-backed sub-layer may be used in combination with a fabric sub-layer or a foamed sub-layer to facilitate the installation the floor covering without any additional adhesive.

According to a particular embodiment, the multi-layer floor covering comprises, from its base to its top:
a fibrous reinforcing layer A′ comprising a polyester non-woven fabric (advantageously for the rail transport field) or glass fibres (advantageously for the aeronautical field),
an adhesive layer B′, for example a copolyester adhesive (advantageously for the rail transport field) or a polyurethane adhesive which is not a TPU (advantageously for the aeronautical field),
a back layer A comprising polyvinyl chloride,
a decorative layer B,
a surface layer C comprising:
a polymer matrix comprising polyvinyl chloride, and
a flame-retardant mineral filler comprising hydrotalcite.

In general, the multi-layer floor covering has a mass per unit surface area advantageously of between 1500 g/m² and 3300 g/m².

The multilayer floor covering has a thickness advantageously of between 0.8 mm and 6 mm, preferably of between 1.1 mm and 2.5 mm

Advantageously, for the maritime field, the floor covering does not comprise a fibrous reinforcing layer A′.

Method of Manufacturing the Multi-Layer Covering

The present invention also relates to a method of manufacturing the multi-layer covering described above. This method comprises, in particular, the following steps:
manufacturing the back layer A, decorative layer B and surface layer C,
assembling said back layer A, decorative layer B, and surface layer C to form the multi-layer floor covering,
optionally, manufacturing the fibrous reinforcing layer A′ and adhesive layer B′, and assembling said fibrous reinforcing layer A′ and adhesive layer B′, to form the multi-layer floor covering.

Preferably, the manufacturing process further comprises manufacturing the fibrous reinforcing layer A′, and assembling it to form the multi-layer floor covering, for example by means of the adhesive layer B′.

For example, the various layers may be prepared separately, for example by calendering, by covering, by pressing or by extrusion. In this case, they may be assembled subsequently, for example, by means of a layer of adhesive or by lamination.

Complex-forming consists of passing layers which are pre-heated to temperature, between two temperature-regulated rollers which exert pressure. These rollers ensure the association of the layers. In this case, the presence of an adhesive layer is not necessary.

Certain layers may also be prepared and assembled simultaneously, for example, by coextrusion. In this case, the presence of an adhesive layer is not necessary.

The thickness of the multi-layer covering does not necessarily correspond to the sum of the thicknesses of the layers because of the association and post-treatment steps: for example, pressing and optional graining.

Advantageously, the complex-forming or lamination temperatures are between 100° C. and 160° C. For example, the pressure exerted during complex-forming (or lamination) may vary from 8 bar to 20 bar, preferably from 10 bar to 15 bar.

### DESCRIPTION OF THE FIGURES

The following figures are provided as illustrative and non-limiting examples:

FIG. 1 is a diagram of a floor covering according to the invention, comprising a back layer A, a decorative layer B, and a surface layer C.

FIG. 2 is a diagram of a floor covering according to the invention, comprising a back layer A, a decorative layer B, and a surface layer C, as well as an underlying fibrous reinforcing layer A′ and an adhesive layer.

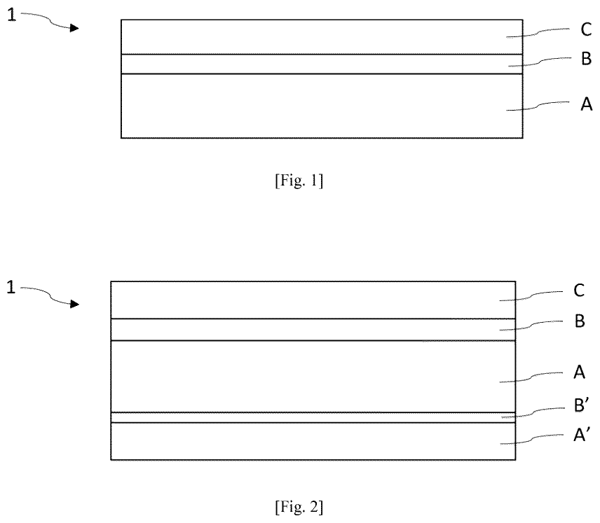

### DETAILED DESCRIPTION OF THE INVENTION

Several multi-layer coatings referenced M1 to M10 have been manufactured.

The coverings M1 to M10 differ only in the nature of their surface layer C, and comprise the same back layers A, decorative layers B, and adhesive layers H making it possible to bond said back layer A with decorative layer B, namely:
a back layer A: 100% PVC+plasticiser+mineral fillers, 1.5 mm thick;
adhesive layer H: copolyamide hot-melt film (coPA), marketed under the reference TC203 by PROCHIMIR;
decorative layer B: complex comprising a glass grid and a polyester non-woven fabric, coated with a pattern applied by digital printing.

The surface layers C of the coverings M1 to M10 are all 0.45 mm thick, and have the following compositions:
M1: PVC plasticised to 38 per with a phosphate plasticiser marketed under the reference Santicizer 141 (S141) by Valtris; the acronym “per” means “percent resin”, it is the quantity (by weight) of plasticiser per 100 parts of resin consisting of PVC and the plasticiser. In the case of the covering M1, the resin consists of 38 parts by weight of Santicizer 141 plasticiser per 100 parts by weight of resin; —M2: PVC plasticised to 38 per with a phosphate plasticiser marketed under the reference Sanitiser 148 (S148) by Valtris; —M3: PVC plasticised with a mixture of two plasticisers marketed respectively under the reference S141 (19 per) and Cereclor S45 (C45) by Ineos (19 per); —M4: PVC plasticised to 38 per with plasticiser S141, additivated with 9% by weight of pyrogenic silica Evonik Aerosil R805; —M5: PVC plasticised to 38 per with plasticiser S141, additivated with 5% by weight of magnesium hydroxide Mg(OH)₂ (MDH) of grade Magnifin H10 from Huber; —M6: PVC plasticised to 38 per with plasticiser S141, additivated with 9% by weight of hydrotalcite no. 1 (HDT-1) of Mg—Zn—Al type; —M7: PVC plasticised to 38 per with plasticiser S141, additivated with 23% by weight of hydrotalcite no. 1 (HDT-1) of Mg—Zn—Al type; —M8: PVC plasticised to 38 per with plasticiser S141, additivated with 33% by weight of hydrotalcite no. 1 (HDT-1) of Mg—Zn—Al type; —M9: PVC plasticised to 38 per with plasticiser S141, additivated with 33% by weight of hydrotalcite no. 2 (HDT-2) of Mg—Al type; —M10: PVC plasticised to 38 per with plasticiser S141, additivated with 33% by weight of hydrotalcite of grade 5944 no. 3 (HDT-3) of Mg—Zn—Al type.

Two 75 mm×75 mm covering samples are produced for each of the coverings M1 to M10. These test pieces are bonded to a 1 mm aluminium substrate with Bostik ISR 7007 adhesive (300 g/m²). After drying the adhesive and conditioning, the samples are tested in a smoke chamber according to the ISO 5659-2 test method in accordance with the R10 requirement of EN45545 (rail transport standard), and then the following are determined:
the density of the smoke (smoke no. 1 and smoke no. 2), which provides an average smoke density for these 2 tests (average smoke);
the gas toxicity index (ITCg) 4 minutes after the start of the test (tox 4 min no. 1 and no. 2), and 8 minutes after the start of the test (tox 8 min no. 1 and no. 2), which provides an average toxicity at 4 minutes (average 4 mins tox) and 8 minutes (8 mins average tox).

The ISO 5659-2 standard corresponds to a fire test in a smoke chamber. The samples are subjected to a radiative flux of 25 kW/m² with pilot flame. The optical density of the smoke is monitored for 20 mins (duration of the test), and the toxicity of the gases is measured following two sampling sessions which take place at 4 mins and 8 mins after the start of the test.

The results obtained are indicated in Table 1 below:

TABLE 1
Smoke density and toxicity values

| Coating | M1 | M2 | M3 | M4 | M5 | M6 | M7 | M8 | M9 | M10 |
|---|---|---|---|---|---|---|---|---|---|---|
| Layer C | PVC | PVC | PVC | PVC | PVC | PVC | PVC | PVC | PVC | PVC |
| | S141 | S148 | S141 | S141 | S141 | S141 | S141 | S141 | S141 | S141 |
| | | | C45 | Silica | MDH | HDT-1 | HDT-1 | HDT-1 | HDT-2 | HDT-3 |
| | | | | | | 9% | 23% | 33% | 33% | 33% |
| Layer B | Complex + pattern by digital printing | | | | | | | | | |
| Layer H | Hot-melt film coPA | | | | | | | | | |
| Layer A | flame retardant PVC formula | | | | | | | | | |
| Smoke nº1 | 364 | 357 | 419 | 288 | 313 | 195 | 183 | 176 | 202 | 231 |
| Smoke nº2 | 330 | 342 | 413 | 297 | 320 | 180 | 146 | 212 | 175 | 204 |
| Smoke | 347 | 350 | 416 | 293 | 317 | 188 | 165 | 194 | 189 | 218 |
| (average) | | | | | | | | | | |
| Tox 4 min | 0.34 | 0.73 | 1.07 | 0.66 | 0.69 | 0.66 | 0.18 | 0.34 | 0.48 | 0.22 |
| nº1 | | | | | | | | | | |
| Tox 4 min | 0.41 | 0.37 | 0.88 | 0.64 | 0.73 | 0.58 | 0.39 | 0.25 | 0.32 | 0.26 |
| nº2 | | | | | | | | | | |
| Tox 4 min | 0.38 | 0.55 | 0.98 | 0.65 | 0.71 | 0.62 | 0.29 | 0.30 | 0.40 | 0.24 |
| (average) | | | | | | | | | | |
| Tox 8 min | 0.4 | 0.6 | 0.76 | 0.63 | 0.54 | 0.57 | 0.24 | 0.38 | 0.47 | 0.24 |
| nº1 | | | | | | | | | | |
| Tox 8 min | 0.35 | 0.28 | 0.65 | 0.47 | 0.51 | 0.48 | 0.31 | 0.26 | 0.3 | 0.28 |
| nº2 | | | | | | | | | | |
| Tox 8 min | 0.38 | 0.44 | 0.71 | 0.55 | 0.53 | 0.53 | 0.28 | 0.32 | 0.39 | 0.26 |
| (average) | | | | | | | | | | |

From these results, it can be seen that the coverings M1, M2, M3, M4, and M5 of the state of the art are not satisfactory because the average smoke density value is greater than 300 (which corresponds to the maximum smoke density acceptable for requirement HL2 of standard EN45545), except for the M4 covering, the average smoke density value of which is however 293, i.e., very close to the threshold value of 300.

In contrast, the coverings M6, M7, M8, M9 and M10 of the invention are satisfactory both for the smoke density (the average smoke density value is less than 200 or very close to 200 for the covering M10), than for the toxicity of gases (the average toxicity values at 4 minutes and 8 minutes are less than 0.90, the maximum toxicity for the HL2 requirement).

In particular, by comparing the M6 covering (9% hydrotalcite) with the control covering M1, it can be seen that the presence of hydrotalcite in the surface layer decreases by (347-188)/347=45% of the smoke density from 9% of the loaded weight of the surface layer C.

The performances are even better in terms of the 23% hydrotalcite in the surface layer C, both for the average density of the smoke (165 for M7 against 188 for M6) and for the average toxicity of the smoke (0.29 for M7 against 0.62 for M6 at 4 minutes, and 0.28 for M7 against 0.53 for M6 at 8 minutes).

The performances remain excellent and similar overall, with 33% hydrotalcite in the surface layer C: M8, M9 and M10 coverings. However, the surface layer C is slightly yellowed.

The surface layers C of the coverings M1, M2, M3, M6, M7 and M8 have a transparency which is acceptable for industrial application. The M4 covering is slightly blue, the M5 covering is slightly opaque, and the M9 and M10 coverings are transparent but have a more yellowish colour.

1. A multi-layer floor covering comprising, from the base to the top of the covering:
a back layer A,
a decorative layer B,
a surface layer C,
wherein the surface layer C comprises:
a polymer matrix comprising polyvinyl chloride, and
a mineral filler comprising hydrotalcite, the hydrotalcite being used as a flame retardant and representing at least 3%, relative to the weight of the surface layer C.

2. The multi-layer floor covering according to claim 1, wherein the surface layer C comprises polyvinyl chloride and hydrotalcite.

3. The multi-layer floor covering according to claim 1, wherein the hydrotalcite represents from 5% to 50% by weight relative to the weight of the surface layer C.

4. The multi-layer floor covering according to claim 1, wherein the hydrotalcite represents from 9% to 33% by weight relative to the weight of the surface layer C.

5. The multi-layer floor covering according to claim 1, wherein the hydrotalcite is of the type [MII1−x MIIIx (OH)2] [An−x/n, yH2O], with:
MII being a divalent metal cation comprising Mg2+ and/or Zn2+,
MIII being an Al3+ trivalent metal cation,
An−: anions,
x: charge density, of between 0.2 and 0.33,
y being between 0 to 10,
n being between 1 to 3.

6. The multi-layer floor covering according to claim 1, wherein the hydrotalcite is in the form of particles with a size of between 200 nm and 1 μm.

7. The multi-layer floor covering according to claim 1, wherein the polyvinyl chloride of the polymer matrix comprises plasticised polyvinyl chloride.

8. The multi-layer floor covering according to claim 1, wherein the surface layer C has a thickness of between 0.1 mm and 2 mm.

9. The multi-layer floor covering according to claim 1, wherein the back layer A comprises a polymer selected from the group consisting of polyvinyl chloride, ethylene vinyl acetate copolymer, and mixtures thereof.

10. The multi-layer floor covering according to claim 1, wherein the multi-layer floor covering comprises, from its base towards its top:
a fibrous reinforcing layer A′ comprising polyester non-woven fabric or glass fibers,
an adhesive layer B′,
the back layer A comprising polyvinyl chloride,
the decorative layer B,
the surface layer C comprising.

11. A method of manufacturing the multi-layer floor covering according to claim 1, comprising the following steps:
manufacturing the back layer A, decorative layer B and surface layer C, and
assembling said back layer A, decorative layer B, and surface layer C.

12. The method according to claim 11, further comprising:
manufacturing the fibrous reinforcing layer A′ and adhesive layer B′, and
assembling said fibrous reinforcing layer A′ and adhesive layer B′, to form the multi-layer floor covering.

13. The multi-layer floor covering according to claim 1 wherein the hydrotalcite being is representing at least 5%, relative to the weight of the surface layer C.

14. The multi-layer floor covering according to claim 1, wherein the hydrotalcite is in the form of particles with a size of between 400 μm and 700 μm.

15. The multi-layer floor covering according to claim 1, wherein the decorative layer B is in the form of a printed substrate or an ink layer printed on the back layer A or on the back of the surface layer C.
